(19) United States
(12) Patent Application Publication
(10) Pub. No.: US 2019/0060796 A1
(43) Pub. Date: Feb. 28, 2019

(54) CENTRIFUGAL FILTER

(71) Applicant: LIS Automatic Controlled Co Ltd, Taichung (TW)

(72) Inventor: Jack Chang, Logan, UT (US)

(73) Assignee: LIS Automatic Controlled Co Ltd, Taichung (TW)

(21) Appl. No.: 16/119,936

(22) Filed: Aug. 31, 2018

(30) Foreign Application Priority Data
Aug. 31, 2017 (TW) 106129693

(51) Int. Cl. B01D 21/26; B04C 5/02; B04C 5/103; B01D 21/00

(52) U.S. Cl. CPC B01D 21/267; B01D 21/0042; B04C 5/103; B04C 5/02

(57) ABSTRACT

The invention relates to a new centrifugal filter for filtering impurities from liquid. Embodiments comprise a cylindrical housing having: (1) a top flow guiding assembly with a top portion having a first liquid outlet, a threaded middle portion, a bottom portion having a plurality of spiral flow guiding grooves adjacent the bottom portion, and a channel through a longitudinal axis; (2) a water inlet flow guiding assembly having a middle portion with a liquid inlet, and a channel through a longitudinal axis; (3) a recessed flow guiding assembly having a channel through a longitudinal axis which forms a conical taper; and (4) an impurity flow guiding assembly having a channel through a longitudinal axis that forms a second liquid outlet; each assembly releasably attachable within the cylindrical housing through threaded means.

### RELATED APPLICATIONS

This application claims foreign priority to a Taiwanese patent application, U.S. Ser. No. P17-0193, filed on Aug. 31, 2017, which application is also fully incorporated herein.

### BACKGROUND OF THE INVENTION

High-pressure coolant systems exist across a wide variety of applications and industries. In merely one of many examples, high-pressure coolant feeders are used in machining or cutting applications. Within these applications, high-pressure coolant feeders typically use a pressure pump for providing coolant at high pressure to machining or cutting locations. Coolant rapidly cools and lubricates these areas. As an undesired side-effect, high-pressure coolant systems may generate large amounts of debris in the cutting area by breaking apart work material. Moreover, high-pressure coolant systems may also introduce stress and extreme directional dynamics to the cutting tool. These conditions may adversely affect processing precision and reduce the service life of cutting or machining tools.

Also, in typical high-pressure coolant systems, the coolant is typically recycled or used cyclically, so it is likely to carry shreds or other impurities from machining or other processes. If impurities are not filtered, the pump motor may be damaged. Accordingly, filtering such impurities with coolant systems is important. Most common filter methods use a paper filter to collect impurities mixed in the coolant. However, such methods tend to cause blocking of the filter pores, thereby requiring frequent maintenance and filter replacement. Furthermore, discarded filters may increase disposal costs and environmental impact.

Thus, a more effective filter that increases processing precision and overall service life of machine components, and that avoids the problems associated with paper filter replacement is needed.

### SUMMARY OF THE INVENTION

A new centrifugal filter for filtering impurities from liquid is provided. Embodiments of the filter comprise a cylindrical housing having a top flow guiding assembly with a top portion having a first liquid outlet, a threaded middle portion, a bottom portion having a plurality of spiral flow guiding grooves adjacent the bottom portion, and a channel through a longitudinal axis of the top flow guiding assembly; a water inlet flow guiding assembly having a middle portion with a liquid inlet, and a channel through a longitudinal axis of the water inlet flow guiding assembly; a recessed flow guiding assembly having a channel through a longitudinal axis of the recessed flow guiding assembly a portion of which forms a conical taper; and an impurity flow guiding assembly having a channel through a longitudinal axis of the impurity flow guiding assembly that forms a second liquid outlet; wherein each of the top flow guiding assembly, water inlet flow guiding assembly, recessed flow guiding assembly, and impurity flow guiding assembly are releasably attachable within the cylindrical housing through threaded means.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through use of the accompanying drawings in which:

FIG. 1A is an exploded view of one embodiment of a centrifugal filter.

FIG. 1B is a perspective view of one assembled embodiment of a centrifugal filter.

FIG. 1C is a cross-sectional view of one embodiment of a centrifugal filter.

FIG. 2 is a cross-sectional view of one embodiment of a centrifugal filter, showing internal coolant dynamics.

### DETAILED DESCRIPTION

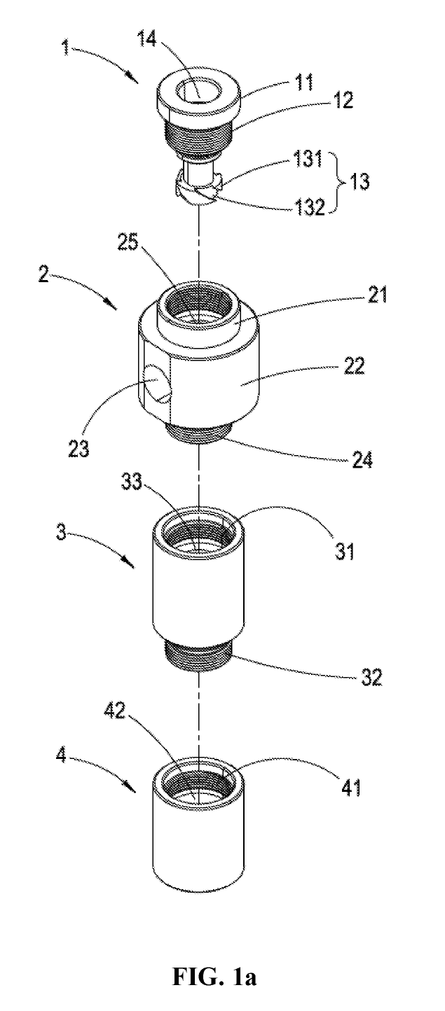

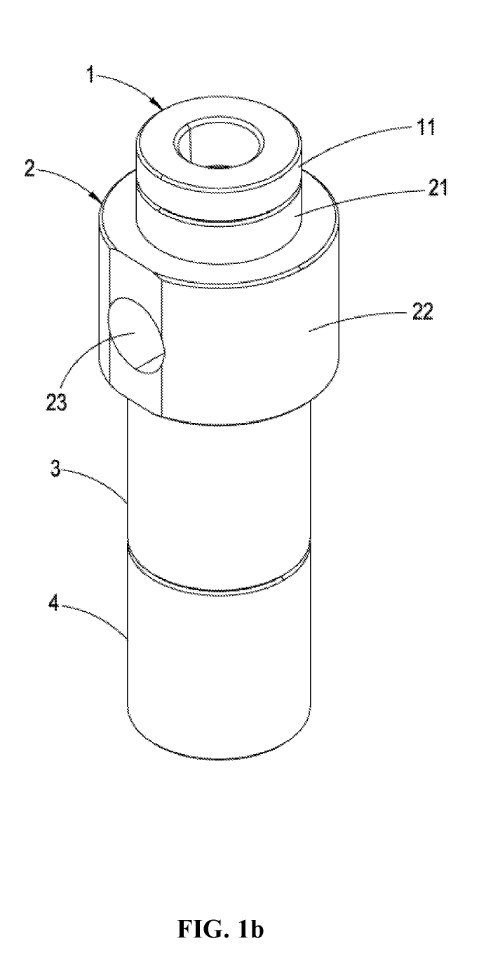

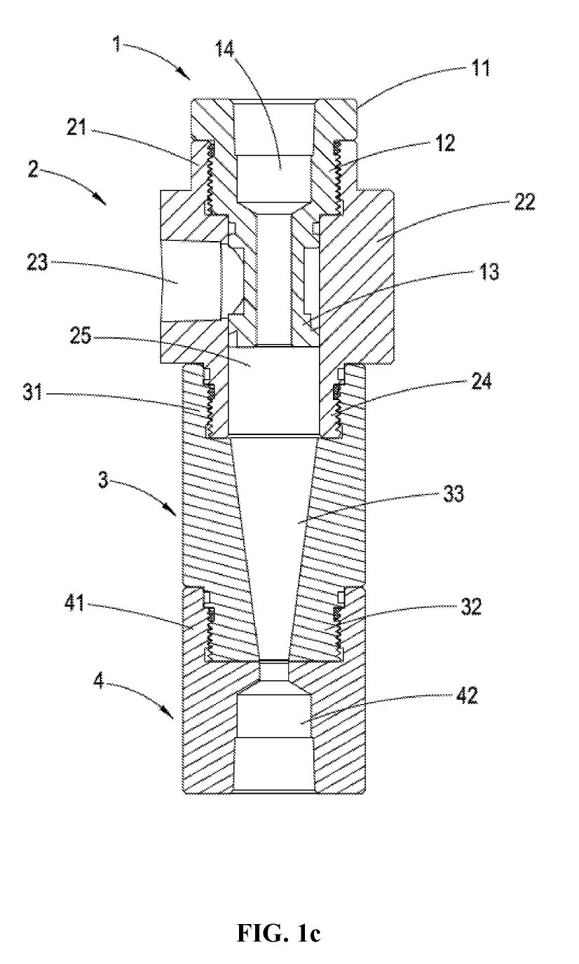

Referring now to FIGS. 1A to 1C, the invention, in its various embodiments, is a new centrifugal filter. The centrifugal filter comprises a top flow guiding assembly 1, a water inlet flow guiding assembly 2, a recessed flow guiding assembly 3, and an impurity flow guiding assembly 4.

The top flow guiding assembly 1 has a top cover portion 11 at a top portion, a first screw connection column 12 at a middle portion, the first screw connection column 12 adjacent to the top cover portion 11, and a flow guiding column 13, distal to the top cover portion 11, and adjacent to the first screw connection column 12. The flow guiding column 13 has a plurality of tilted ribs 131 with a plurality of spiral flow guiding grooves 132. The top flow guiding assembly 1 also has a first through channel 14 that passes through a longitudinal axis of the top flow guiding assembly 1.

The water inlet flow guiding assembly 2 has a first screw connection portion 21 at a top portion configured to thread with and connect to the first screw connection column 12 of the top flow guiding assembly 1. Adjacent to the first screw connection portion 21, is a water inlet portion 22 having a water inlet opening 23 that passes through water inlet portion 22 at an angle generally perpendicular to a longitudinal axis of the centrifugal filter. Water inlet flow guiding assembly 2 further has a second screw connection portion 24 at a bottom portion (opposite the first screw connection portion 21). Water inlet flow guiding assembly 2 has a through channel 25 passing through the water inlet flow guiding assembly 2 at a longitudinal axis.

Recessed flow guiding assembly 3 has a first screw connection portion 31 at a top portion configured to thread with and connect to water inlet flow guiding assembly's 2 second screw connection portion 24. Recessed flow guiding assembly 3 has a second screw connection portion 32 at a bottom portion (opposite the first screw connection portion 31). Inner portion of the recessed flow guiding assembly 3 has a through channel 33 passing through the recessed flow guiding assembly 3 at a longitudinal axis, the through channel 33 is a channel structure having an upper end that is wider than the lower end, forming a conical taper.

Impurity flow guiding assembly 4 has a first screw connection portion 41 at a top end configured to thread with and connect to recess flow guiding assembly's second screw connection portion 32. Impurity flow guiding assembly 4 also has a through channel 42 passing through the impurity flow guiding assembly 4 at a longitudinal axis.

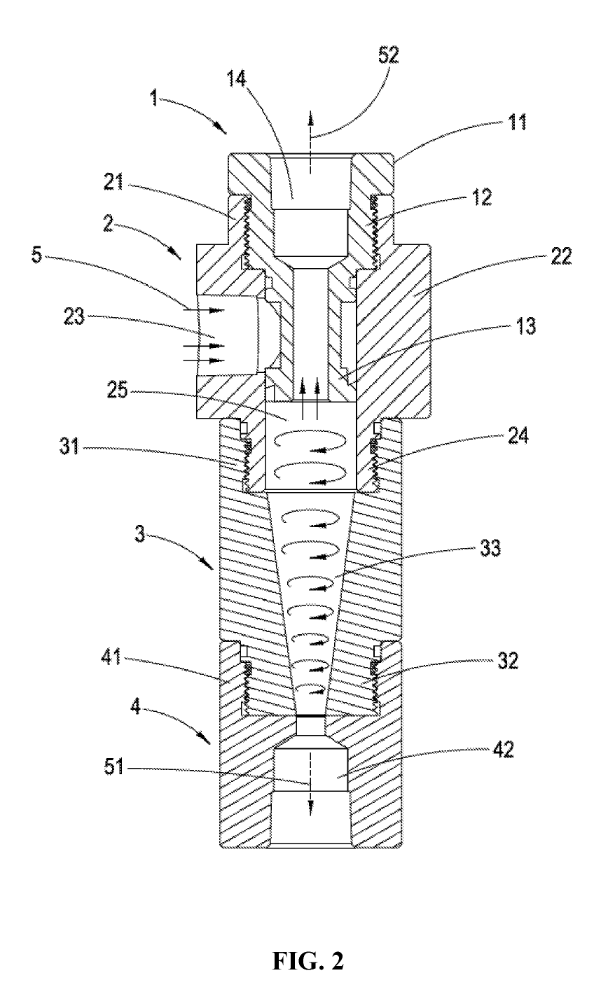

Referring now to FIG. 2, in operation, after the top flow guiding assembly 1 is connected to the water inlet flow guiding assembly 2, the position of the water inlet opening 23 corresponds to the positions of the spiral flow guiding grooves 132 of the flow guiding column 13 in a horizontal plane such that, after a liquid 5 is injected into the water inlet opening 23 in a high-pressure manner, the liquid 5 is divided into a plurality of flows along the spiral flow guiding grooves 132, which allow the liquid to convolute and move downwardly into the through channel 33 of the recessed flow guiding assembly 3.

Because the specific weights of heavier impurity components in the liquid 5 are greater, these impurity components will continuously collide with the inner walls of the through channel 25 of the water inlet flow guiding assembly 2 and the through channel 33 of the recessed flow guiding assembly 3 as a result of the liquid convolution forces from the spiral flow guiding grooves 132. Any liquid with impurity components 51 will gradually separate from the liquid without impurity components 52.

In addition, because the through channel 33 of the recessed flow guiding assembly 3 is a tapered channel structure with a wider upper end and a narrower lower end, the injected liquid will be influenced by the narrower bottom of the through channel 33 so as to cause the liquid with the impurity components 51 to move downwardly and cause the liquid without the impurity components 52 to stay at the top. Thus, when more liquid 5 is injected, the liquid 52 without the impurity components will naturally convolute upwardly and successively pass the through channel 33 of the recessed flow guiding assembly 3, through channel of the water inlet flow guiding assembly 2, and through channel 25 of the top flow guiding assembly 1. Top cover portion 11 outwardly discharges the liquid 52 without the impurity components.

In addition, in the above operation, the existence of the spiral flow guiding grooves 132 are mainly used to cause the liquid 5 to be divided and convolute. The more bends the spiral flow guiding grooves 132 have, the easier the liquid 5 is divided into a plurality of flows, so that the separated impurity components are smaller. Hence, the purpose of effectively separating impurity components can be achieved by designing the shapes of the tilted ribs 131 so as to change the number of the bends and the sizes of the channels of the spiral flow guiding grooves 132.

Furthermore, because the specific weight of the liquid with the impurity components 51 is greater, the liquid 51 will flow downwardly into the channel 42 of the impurity flow guiding assembly 4. A bottom portion of the impurity flow guiding assembly 4 may further be connected to at least one conduit and be configured to outwardly discharge the liquid with the impurity components 51 through the conduit.

Thus configured, embodiments of the present invention can (1) filter shreds or other impurities in the coolant via a device before the coolant enters the motor so as to prevent the motor from being damaged by shreds and other impurities; and (2) the spiral flow guiding grooves and the channel structure with a wider upper end and a narrower lower end of the centrifugal filter of the present invention can cause the impurity components having greater specific weights to naturally sink and cause the clean water to be discharged upwardly so as to prevent the motor connected to the centrifugal filter from being damaged by shreds and other impurities in the liquid.

The present invention may be embodied in other specific forms without departing from its spirit or essential characteristics. For example, the centrifugal filter may be utilized in applications beyond machining or cutting, to any number of applications where liquid filtering is desired. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A centrifugal filter for filtering impurities from liquid, comprising:
a cylindrical housing with
an inlet configured to introduce liquid into the housing;
a top end with a first liquid outlet;
a bottom end with a second liquid outlet;
a channel between the top and bottom ends, the channel having a length that is a tapered portion; and
a plurality of spiral flow guiding grooves along a horizontal plane of the inlet, the plurality of spiral flow guiding grooves configured to guide liquid from the inlet down into the tapered portion so that liquid with impurities exits the second liquid outlet and liquid with relatively fewer impurities exits the first liquid outlet.

2. The centrifugal filter of claim 1, wherein the cylindrical housing is comprised of two or more threaded components configured to releasably attach within the cylindrical housing.

3. The centrifugal filter of claim 1, wherein the cylindrical housing is comprised of a plurality of threaded components configured to releasably attach within the cylindrical housing.

4. The centrifugal filter of claim 1, wherein the cylindrical housing is comprised of four or more threaded components configured to releasably attach within the cylindrical housing.

5. A centrifugal filter for filtering impurities from liquid, comprising a cylindrical housing having:
a top flow guiding assembly with
a top portion having a first liquid outlet,
a threaded middle portion,
a bottom portion having a plurality of spiral flow guiding grooves adjacent the bottom portion, and
a channel through a longitudinal axis of the top flow guiding assembly;
a water inlet flow guiding assembly having
a middle portion with a liquid inlet, and
a channel through a longitudinal axis of the water inlet flow guiding assembly;
a recessed flow guiding assembly having a channel through a longitudinal axis of the recessed flow guiding assembly a portion of which forms a conical taper; and
an impurity flow guiding assembly having a channel through a longitudinal axis of the impurity flow guiding assembly that forms a second liquid outlet,
wherein each of the top flow guiding assembly, water inlet flow guiding assembly, recessed flow guiding assembly, and impurity flow guiding assembly are releasably attachable within the cylindrical housing through threaded means.

6. The centrifugal filter of claim 5, wherein the water inlet flow guiding assembly and recessed flow guiding assembly each have top and bottom ends with a threaded portion adjacent each end.

7. The centrifugal filter of claim 6, wherein the top flow guiding assembly threaded middle portion is configured to releasably attach to the threaded portion adjacent the top end of the water inlet flow guiding assembly.

8. The centrifugal filter of claim 6, wherein the threaded portion adjacent to the bottom end of the water inlet flow guiding assembly is configured to releasably attach to the threaded portion adjacent the top end of the recessed flow guiding assembly.

9. The centrifugal filter of claim 6, the impurity flow guiding assembly has a top end with a threaded portion adjacent the top end that is configured to releasably attach to the threaded portion adjacent the bottom end of the water inlet flow guiding assembly.

10. The centrifugal filter of claim 5, wherein the liquid inlet and plurality of spiral flow guiding grooves are located along the same horizontal plane when the cylindrical housing is assembled such that the plurality of spiral flow guiding grooves guide liquid down into the tapered portion so that liquid with impurities exits the second liquid outlet and liquid with relatively fewer impurities exits the first liquid outlet.
